(19) United States
(12) Patent Application Publication
(10) Pub. No.: US 2010/0190117 A1
(43) Pub. Date: Jul. 29, 2010

(54) BURNER OPERATION AND INSTALLATION

(75) Inventors: Brendan KEMP, Sevenoaks (GB); Andrew John WEBB, London (GB)

Correspondence Address: MERCHANT & GOULD PC, P.O. BOX 2903, MINNEAPOLIS, MN, 55402-0903, US

(73) Assignee: Autoflame Engineering Limited, Kent (GB)

(21) Appl. No.: 12/465,411

(22) Filed: May 13, 2009

(30) Foreign Application Priority Data
Jan. 26, 2009 (GB) 0901284.0
Apr. 24, 2009 (GB) 0907125.9

(51) Int. Cl. F23N 5/00; G01N 7/00

(52) U.S. Cl. 431/2; 110/341; 431/13; 110/234; 73/23.31

(57) ABSTRACT

A burner is operated by providing a monitoring unit and monitoring the firing rate of the burner and feeding an input signal representing the firing rate to the monitoring unit. The respective proportions of gases in exhaust emissions from the burner are monitored and input signals representing the respective proportions are fed to the monitoring unit. From a combination of the input signals representing the firing rate of the burner and the respective proportions of gases in exhaust emissions, the amounts of one or more of the gases emitted from the burner are calculated in the monitoring unit. At least one of the amounts is displayed.

The present invention relates to a method of operating a burner and to a burner installation. Such a burner installation may, for example, be of the kind used in an industrial boiler. The invention relates more particularly to the monitoring of emissions from a burner.

It is already known to monitor the emissions from a burner. For example EP 0 195 866 describes a fuel burner controller in which the proportions of certain products in the exhaust gases emitted from a burner are monitored and the proportion of air to fuel in the burner adjusted in order to reduce the proportion of an undesirable product in the exhaust gas.

Currently it is possible to make various calculations offline in order to provide an estimate of the amount of a particular exhaust product emitted from a burner over an extended period of time. For example, it may be possible to estimate the amount of fuel burnt over an extended period of time and, from measurements of the proportion of a product in the exhaust gases emitted from the burner, estimate the total amount of the particular exhaust product emitted. Such estimates are, however, somewhat slow and complicated and may also not be very accurate.

The present invention seeks to provide a method of operating a burner and a burner installation in which it is possible to indicate the momentary and/or aggregate amount of a gas emitted from the burner.

According to the invention there is provided a method of operating a burner including:

providing a monitoring unit;

monitoring the firing rate of the burner and feeding an input signal representing the firing rate to the monitoring unit;

monitoring the respective proportions of a plurality of gases in exhaust emissions from the burner and feeding input signals representing the respective proportions to the monitoring unit;

calculating in the monitoring unit, from a combination of the input signals representing the firing rate of the burner and the respective proportions of gases in exhaust emissions, the amount of one or more of the plurality of gases emitted from the burner; and

displaying at least one of the amounts on a display.

By providing a monitoring unit which receives both an input signal representing the firing rate of the burner and an input signal representing the proportion of a gas in the exhaust emissions of the burner, it becomes possible to calculate in the monitoring unit the amount of an exhaust gas and that amount can then be displayed by the monitoring unit. That makes it very easy to see, in real time, the amount of a gas emitted.

The monitoring unit preferably calculates the momentary amount of one or more of the plurality of gases emitted from the burner. More preferably, the monitoring unit calculates the momentary amount of one or more of the plurality of gases emitted from the burner a multiplicity of times and stores the results of each calculation in the monitoring unit. Once there is a series of values for the momentary amounts of gases emitted from the burner stored in the monitoring unit, it becomes possible to display a wide variety of data regarding emissions.

Where the term “momentary” is used herein, it should be understood that this may refer to very short timescales of fractions of a second or longer timescales such as a minute or longer, those timescales still being less than one hour and therefore short compared to the period of operation of the burner. Also, the “momentary” amount may itself be a combination (for example, an average) of a plurality of individual data results. In an embodiment of the invention described below individual data results are obtained every second and “momentary” amounts calculated every minute.

The monitoring unit preferably calculates the aggregate amount of one or more of the plurality of gases emitted over a period of time from the burner. For many purposes it is useful for a user to be able to see readily the total amount of a gas emitted over an extended period of time. There are various ways in which the total amount of a gas emitted may be calculated, but in a preferred arrangement the monitoring unit calculates the aggregate amount by calculating the momentary amount a multiplicity of times and integrating the results.

The display may be capable of displaying a wide variety of parameters, optionally at the choice of a user. Preferably said at least one of the amounts displayed includes the momentary rate of emission of an exhaust gas. Preferably said at least one of the amounts displayed also or alternatively includes the aggregate amount of an exhaust gas emitted over a period of time. In the latter case the period of time over which the aggregate amount emitted is displayed is preferably able to be altered by a user.

The method is preferably able to be carried out with any of a plurality of different fuels. For different fuels the proportions of various gases emitted will vary and account has to be taken of this if the method is to be able to be carried out with different fuels. Preferably, the method further includes the step of feeding an input signal to the monitoring unit indicating the type of fuel being fed to the burner. The input signal can be input by a user selecting which of several fuels is being used. That option is practical because the number of fuels commonly fed to burners are limited in number so that typically a selection need be made between no more than ten fuels, for each of which the monitoring unit may be provided with stored data. The input signal can also be provided from another control unit that may be provided for controlling the burner. For example there may be a control unit of the kind defined in GB 2138610 for controlling the burner. The stored data may include one or more of the following for each fuel: the chemical composition; the hydrocarbon ratio; the calorific value.

In the description of the invention above, reference has been made to calculating the amount of just one of the plurality of gases and displaying that. Whilst that is in accordance with the broadest aspect of the invention, it is preferred that the amounts of each of the plurality of gases whose proportions are monitored are calculated in the monitoring unit. Similarly it is preferred that the amounts of each of the plurality of gases whose proportions are calculated are displayed.

An especially advantageous feature of the invention is that the display includes a touch screen through which an input to the monitoring unit is provided. Preferably the touch screen and the display are at least partially coincident. That enables a very simple and adaptable user interface to be provided and enables a user to be given very simple control of the data that is displayed.

Preferably the display is capable of displaying simultaneously emissions data relating to a plurality of exhaust gases. Preferably a user is able to select for which one or ones of the plurality of exhaust gases emissions data is displayed. In a case where a touch screen is provided, that is preferably accomplished by touching an indicated area of the screen. Preferably in a case where emissions data is displayed graphically, a user is able to adjust a scale on one or both axes. One axis may relate to the amount of a gas emitted; another axis may relate to a time period.

The step of monitoring the firing rate of the burner preferably comprises monitoring the flow rate of fuel to the burner. The fuel may be a gas or may be oil. The flow rate of the fuel is preferably monitored directly, but it may alternatively be measured indirectly; for example the air flow rate may be monitored or a command signal from a controller representing a desired fuel or air flow rate may be monitored.

According to the invention there is also provided a burner installation including:

a burner;

a monitoring unit including a housing and a display;

a monitor for monitoring the firing rate of the burner and feeding an input signal representing the firing rate to the monitoring unit;

exhaust gas analysis equipment for monitoring the respective proportions of a plurality of gases in exhaust emissions from the burner and feeding input signals representing the respective proportions to the monitoring unit; and

a calculating unit in the monitoring unit for calculating, from a combination of the input signals representing the firing rate of the burner and the respective proportions of gases in exhaust emissions, the amount of one or more of the plurality of gases emitted from the burner.

The exhaust gas analysis equipment may take any of a wide variety of forms. Preferably the equipment includes means for removing moisture from combustion product samples and means for sensing the respective proportions of a plurality of gases in the samples after removal of the moisture. The means for removing moisture from the samples preferably includes means for chilling the samples, and more preferably for chilling the samples to a temperature below 5° C. The means for sensing the respective proportions of gases preferably includes an absorption sensing means.

The calculating unit is preferably arranged to calculate the momentary amount of one or more of the plurality of gases emitted from the burner. Preferably the monitoring unit includes a store and the calculating unit is arranged to calculate the momentary amount of one or more of the plurality of gases emitted from the burner a multiplicity of times and to store the results of each calculation in the store. By storing such momentary values as raw data, it becomes possible in a simple way to calculate and/or display values for any of a wide variety of parameters.

The monitoring unit is preferably arranged to calculate the aggregate amount of one or more of the plurality of gases emitted over a period of time from the burner.

The monitoring unit is preferably arranged to receive an input signal indicating the type of fuel being fed to the burner.

In an especially advantageous arrangement the display includes a touch screen for enabling an input to the monitoring unit to be provided. It is particularly preferred that the input signal indicating the type of fuel being fed to the burner is provided by an input via the touch screen. The touch screen is preferably able to display a plurality of different input screens. Additionally or alternatively, the touch screen is preferably able to display a plurality of different output screens. In that way, a great deal of information can be presented to a user in a relatively large and clear format without having to make the touch screen especially big.

The monitoring unit may be divided into two or more physically separate modules but preferably there is a single module in which the monitoring unit is accommodated. The housing of the monitoring unit preferably includes a top face on which the display and the touch screen are provided. The display and the touch screen are preferably substantially coincident. Preferably they occupy more than fifty percent, and more preferably more that 65 percent of the area of the top face. The housing may be of substantially cuboidal shape with the top face of the cuboid substantially covered by the display.

The monitoring unit may include a detachable memory device on which some or all of the data may be stored. The detachable memory device may, for example, be connectible to a laptop computer.

In the description above, certain features of the invention have been described only in relation to the method of the invention and other features of the invention have been described only in relation to the burner installation. It should be understood, however, that a feature described only in relation to the method of the invention may be employed in the burner installation of the invention and vice versa.

By way of example an embodiment of the invention will now be described with reference to the accompanying drawings, of which:

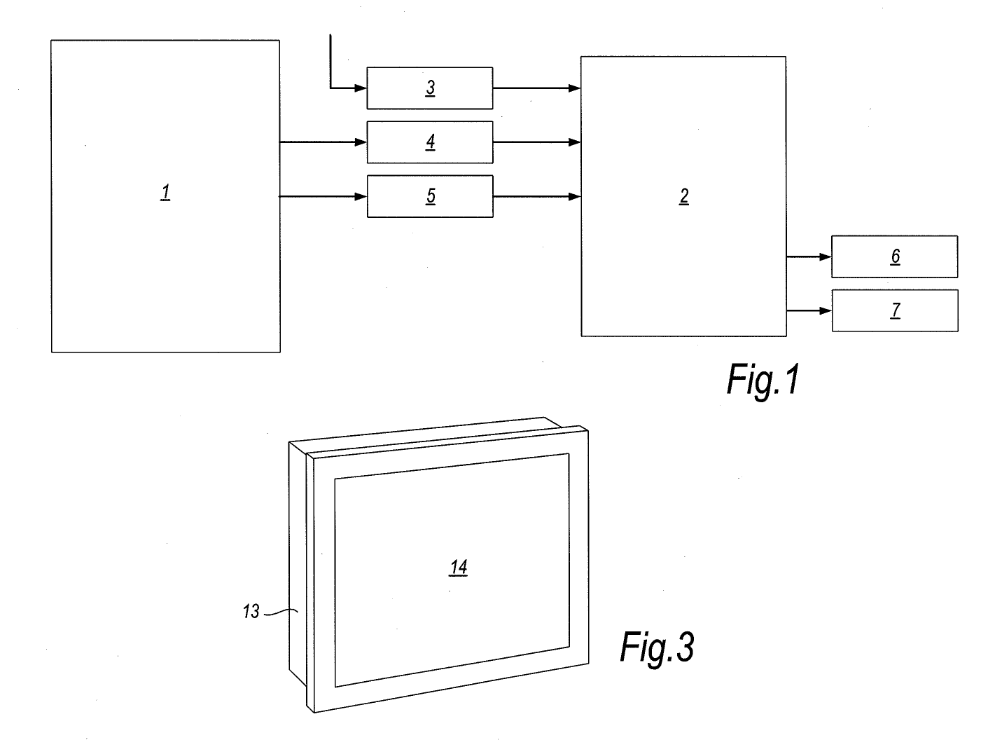

FIG. 1 is a schematic block diagram showing an overview of a burner installation incorporating a monitoring unit and embodying the invention;

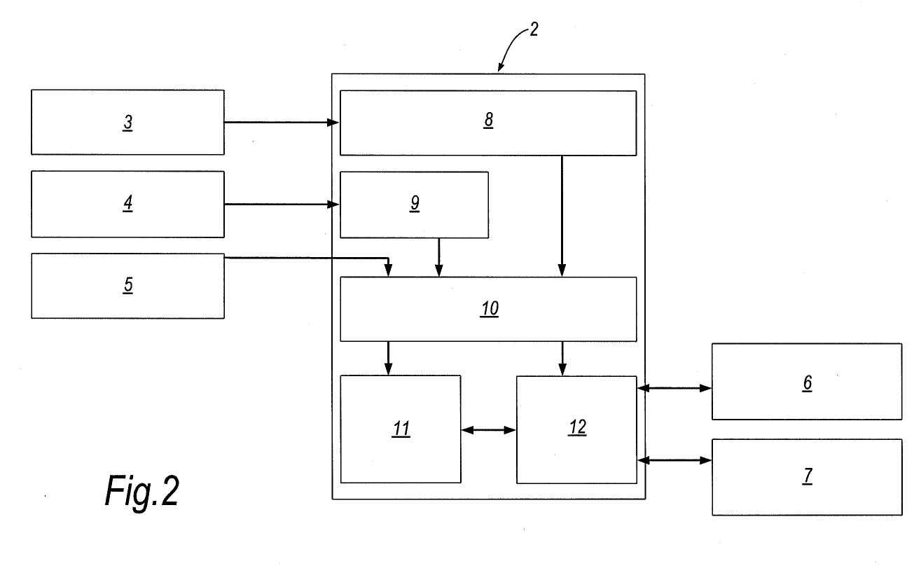

FIG. 2 is a schematic block diagram of the monitoring unit including inputs to and outputs from the unit;

FIG. 3 is an isometric view of the monitoring unit;

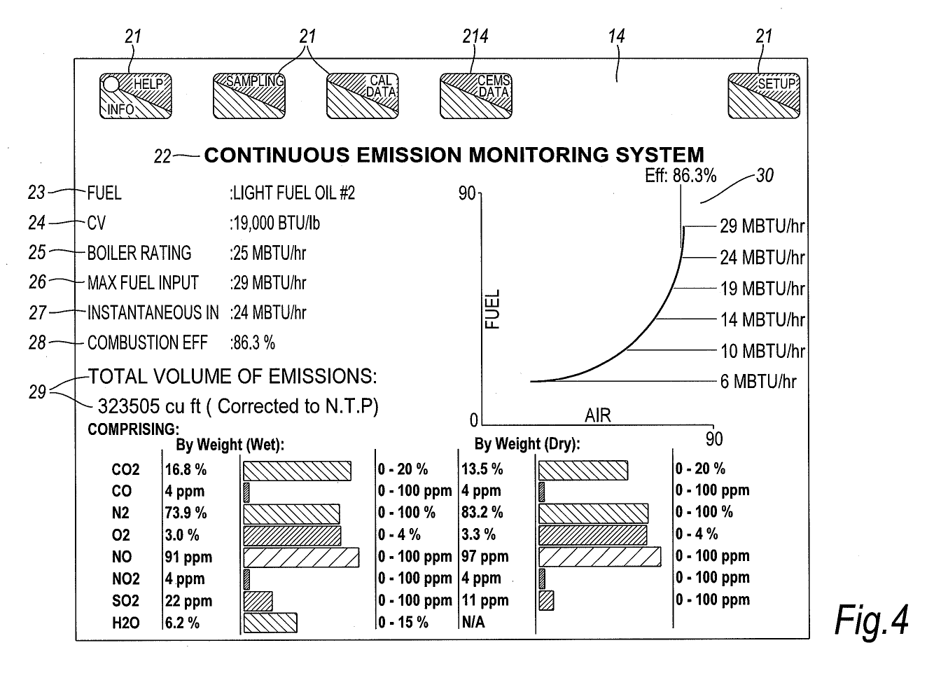

FIG. 4 is a screenshot of one potential display that may be present on the monitoring unit; and

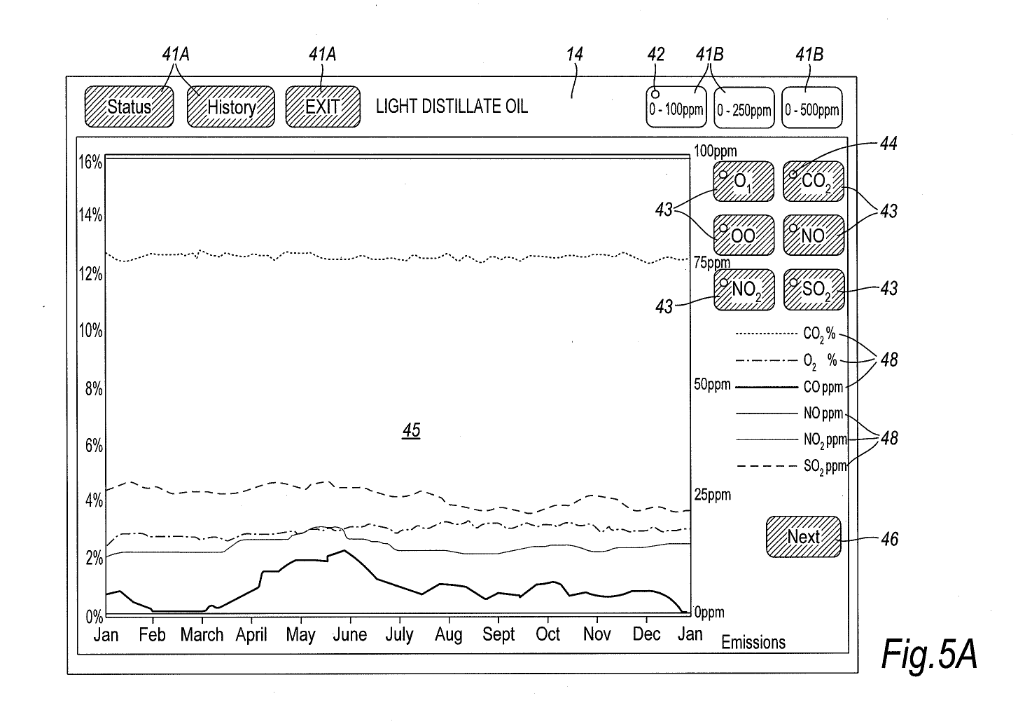

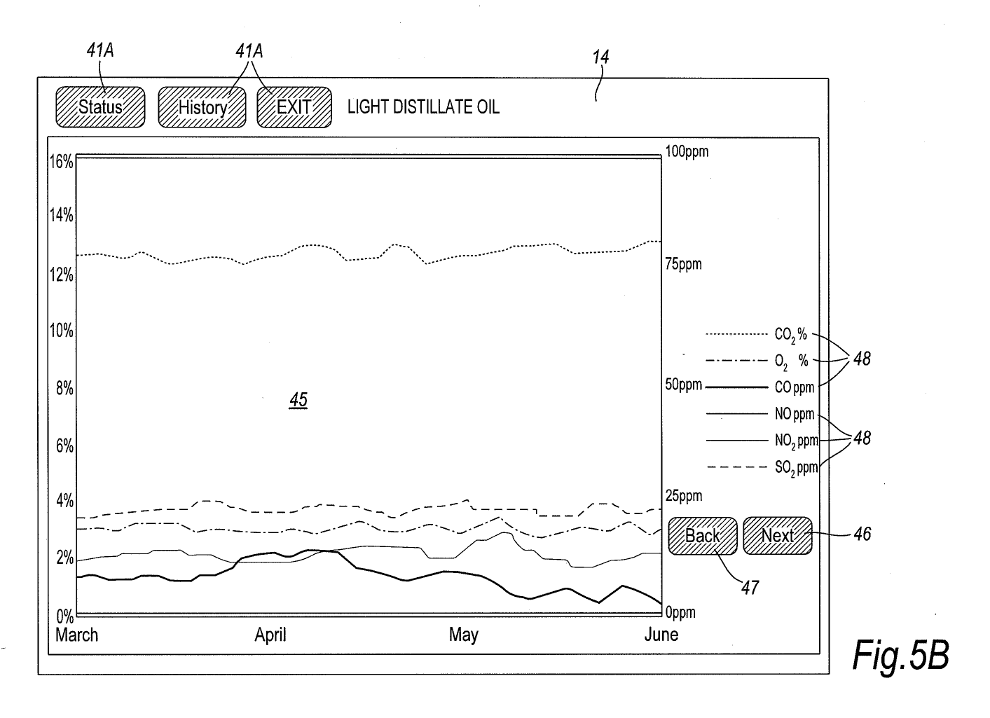

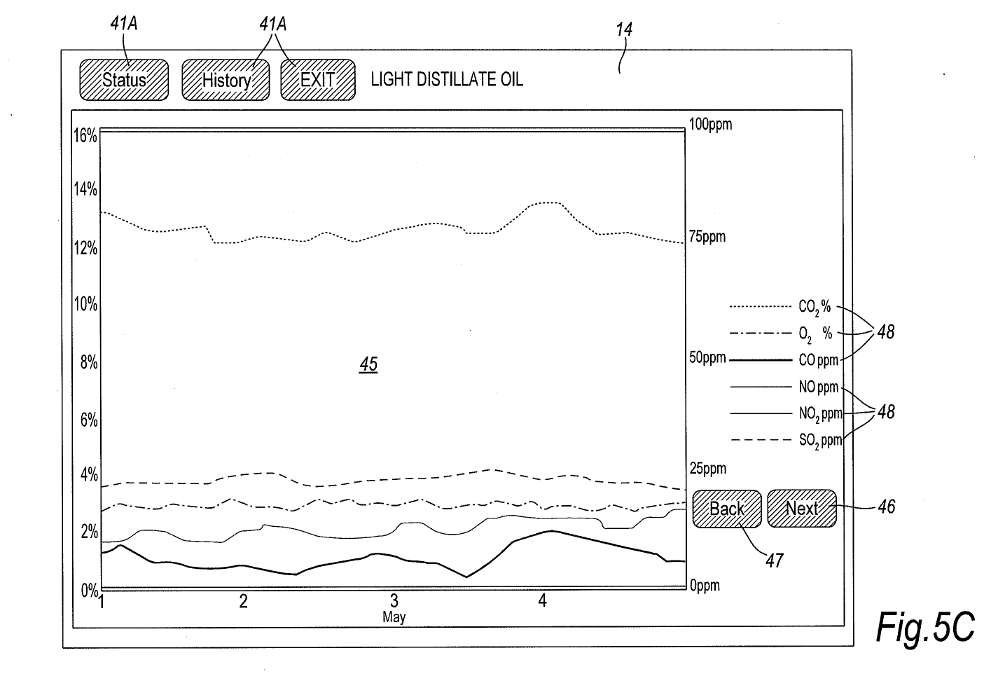

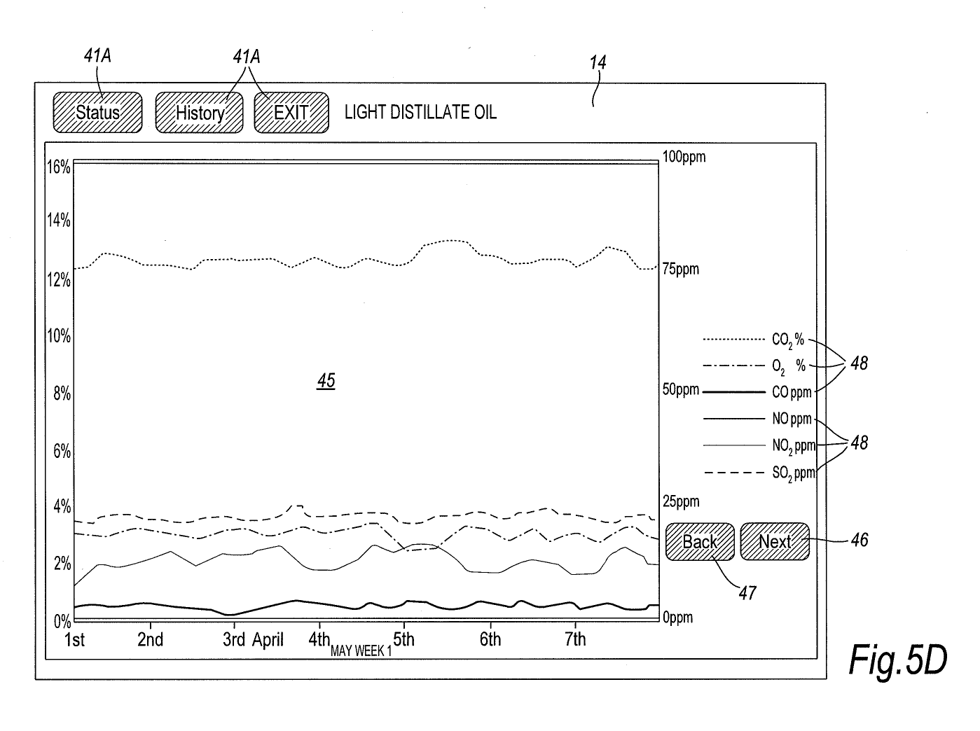

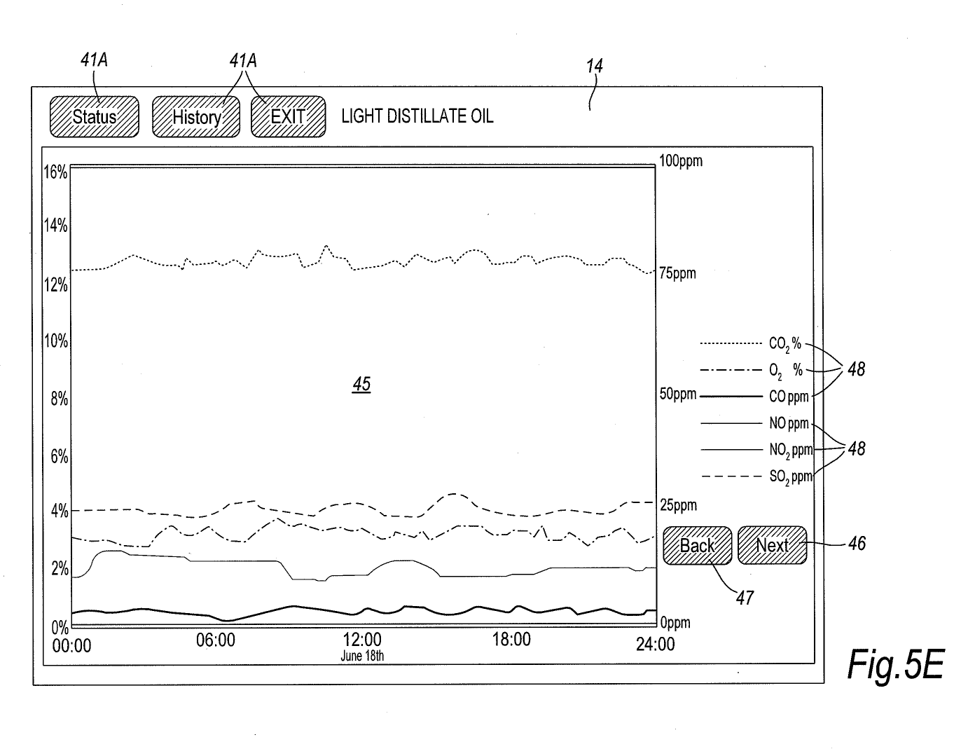

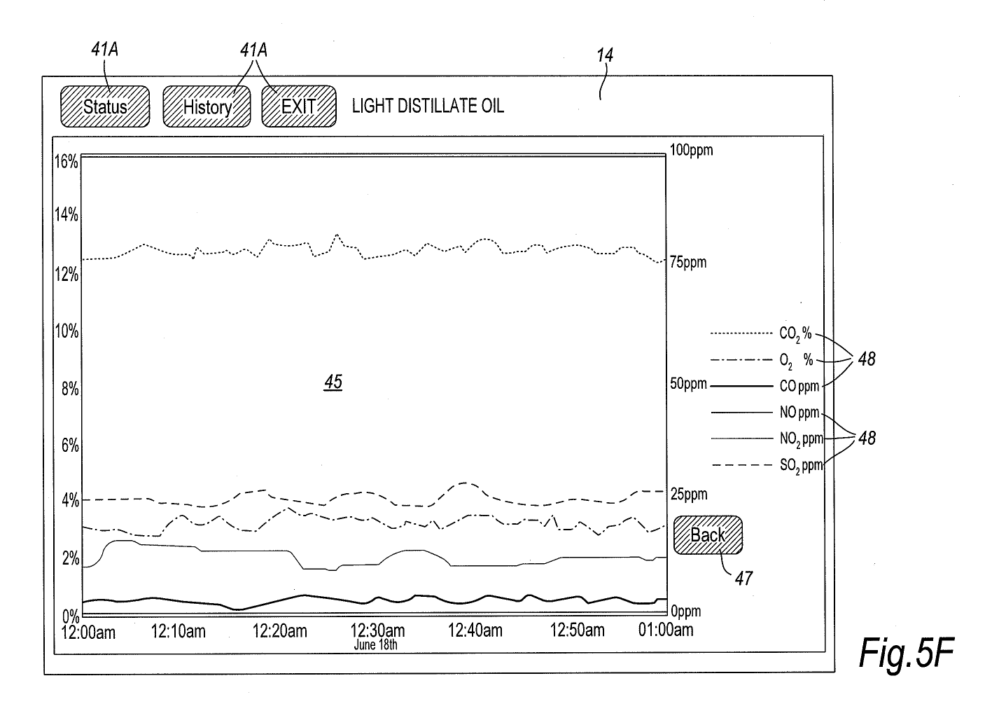

FIGS. 5A to 5F are screen shots of another series of displays that may be present on the monitoring unit.

Referring first to FIG. 1, the burner installation shown therein generally comprises a burner 1, and a monitoring unit 2. The monitoring unit 2 receives inputs of three kinds represented by the blocks 3, 4 and 5 in FIG. 1. Block 3 represents a fuel selection input which is provided directly by a user as will be explained below. Block 4 represents an exhaust gas sampling system which monitors emissions of the burner 1, obtains data therefrom and feeds the data into the monitoring unit 2. Block 5 represents a fuel flow rate monitoring system which monitors the rate of flow of fuel into the burner, which is indicative of the firing rate of the burner, and feeds the data into the monitoring unit 2.

The monitoring unit 2 provides, at its most basic level, two kinds of outputs represented by blocks 6 and 7 in FIG. 1. Block 6 represents an output indicating the amounts of certain exhaust gases being emitted by the burner at that moment. Block 7 represents an output indicating the total amounts of certain exhaust gases emitted over a period of time. As will be explained in more detail below those outputs can be illustrated on a touch screen display and/or in other ways.

Referring now also to FIG. 2, the fuel selection input is provided by a user simply selecting which of several fuels (there are about ten fuels commonly used by industrial burners including for example Natural Gas and Heavy Fuel Oil) is being burnt by the burner. The monitoring unit 2 includes a fuel database 8 in which the following data is stored:

(a) the chemical composition of each fuel

(b) the hydrocarbon ratio

(c) the calorific value.

Whilst the database is pre-loaded with data for common fuels a facility is also provided to enable a user to input the required data (through the touch screen display described below) for other fuels.

The exhaust gas sampling system 4 takes a small portion of exhaust gas from the flue gas duct and passes it through a chilling unit which removes water from the sample by condensation. It is then taken through a pump and from the outlet of the pump it is, in this particular example, passed across six chemical analysis cells which detect the proportions of oxygen, carbon monoxide, carbon dioxide, nitrous oxide, nitrogen dioxide and sulphur dioxide in the gas. Each cell quantifies the volume concentration of the particular gas with which it is dealing.

The chilling unit that is used for removing water vapour from the sample gas operates and is configured in the following way. The sample gas is taken through an aluminium block which has two cylindrical cores. Around each of the cylindrical cores a helical groove is cut and the sample gas is taken down and around one helical core and up and around the other. The whole aluminium unit including cores is maintained at a temperature of 2° C. The cooling is caused by a Peltier thermal transducer which transfers heat from the block into a heat sink which is then cooled by a fan blowing ambient air across it. The water collected during the cooling process is taken out through the bottom of the block via a drain which is periodically emptied. This drain connection serves a second purpose which is as a source of reference air which is chilled until it reaches the same relative humidity as the sample gas. This chilled reference air is periodically passed across the cells to recalibrate them.

Signals from the exhaust gas sampling system 4 are passed to a sample management unit 9 in the monitoring unit 2. The sample management unit 9 provides an input to a processor unit 10 in the monitoring unit 2, that input representing the proportion of each monitored gas in the exhaust emissions. The processor unit 10 also receives an input from the fuel database 8 and from the burner 1 (usually from a control unit controlling operation of the burner) indicating the fuel flow rate. The input of fuel flow rate is continuously updated and the input from the sample management unit 9 is updated at very short time intervals. In a particular example the input is updated every second. An input of air flow rate may similarly be provided.

The processor unit 10 can readily calculate the total exhaust emissions rate for the moment to which the fuel flow rate relates by combining the fuel flow rate input with the fuel database input and can then use the input from the sample management unit 9 to calculate the rate of emission of each of the sampled gases. Those calculations can be performed many times per minute and the data from them stored in a storage database 11. In one example, the calculations are performed every second and the results from sixty calculations averaged and stored in the database 11 as a single value. A query interface 12 provides an interface between the storage database 11 and the processor unit on the one hand, and output displays and touch screen inputs provided to and from the touch screen which may be regarded as represented in FIG. 2 by the blocks 6 and 7 which incorporate the touch screen outputs of momentary and aggregate emissions.

FIG. 3 shows a typical functional arrangement for the monitoring unit 2 including the blocks 6 and 7 of FIGS. 1 and 2. The monitoring unit 2 has a housing 13 of generally cuboidal shape and the top face of the housing is provided with a touch screen 14 which occupies about 75 percent of the area of the top face. The touch screen 14 provides both a method by which a user can input data into the query interface 12 and also a display by which information from the query interface can be provided. In addition to a display output, the query interface may be connected to a variety of other interfaces such as Ethernet, RS-232 or USB, for one- or two-way communication with the interface 12. The housing 13 may also contain an electronic control unit for carrying out the processing of the signals obtained from the exhaust gas analysis and thus part of the exhaust gas sampling system 4 may be contained within the housing 13. In that case the display and touch screen 14 may also be used by the exhaust gas sampling system 4.

The touch screen display may provide a variety of different displays. FIG. 4 shows one example of a display that may be shown on the touch screen 14. It should be understood that this is just a first example of a great many displays that may be shown.

Across the top of the display are five rectangles 21 inviting the user to enter a signal by touching a chosen one of the rectangles. Of course touching a selected rectangle will lead to a new display with new options. Indeed the display shown by way of example in FIG. 4 is obtained by touching the fourth rectangle from the left, referenced 214 in FIG. 4 and making further selections thereafter.

The information displayed on the screen 14 is as follows:
a title 22 at the top;
a line 23 of text indicating the particular fuel that is being burnt;
a line 24 of text indicating the calorific value (CV) in Imperial units of that particular fuel;
a line 25 of text indicating the boiler rating in Imperial units of the particular boiler with which the burner is associated;
a line 26 of text indicating in Imperial units the heat input of the burner at maximum fuel input;
a line 27 of text indicating the momentary heat input in Imperial units at that moment of burner;
a line 28 of text indicating the momentary combustion efficiency;
two lines 29 of text indicating the total volume of emissions in Imperial units since some reference time, which may be as long ago as when the burner was first commissioned or some other reference point, the volume being adjusted to normal temperature and pressure (which may be 20° C. and atmospheric pressure);
a graph 30 to the right of lines 23 to 29 of the text showing fuel input plotted on the y-axis against air flow on the x-axis, with scales on each axis being the angle of opening of a valve which is rotatable through ninety degrees between fully closed and fully open positions; on the right hand side the heat input in Imperial units corresponding to a given fuel valve setting is shown; the fixed fuel to air valve settings that are employed in practice are represented by a curved line on the graph, that relationship being governed by the programming of the control of the burner and a vertical line marks the position on the curved line where the burner is at that moment operating: in the example shown the vertical line therefore intersects the curved line at a fuel input of 24 MBTU/hr as per line 27 of the text, that being the momentary fuel input in the example shown; at the top of the vertical line is text indicating the momentary efficiency of the burner and corresponding to the data in line 28 of the text.

In the example shown in FIG. 4, below the information referred to above are tables and bar graphs showing the breakdown into different gases of the total emissions given in the two lines of text referenced 29 in FIG. 4. The proportions of water, nitrogen and the six gases analysed are given: for those gases representing a relatively high proportion of the emissions a percentage is given and for those gases with a much smaller proportion the figures are given in parts per million (ppm). On the left hand side numerical values and bar graphs are given for proportions by weight (wet) and on the right hand side numerical values and bar graphs are given for proportions by volume (dry).

In FIG. 4 the display is shown in black and white but it should be understood that the display is preferably a colour display.

In the example shown in FIG. 4, the data concerning emissions is related to total emissions over an extended period of time, but it should be understood that another display that is available is of the momentary emissions.

FIG. 5A shows a second example of a display that may be shown on the touch screen 14.

Across the top of the display are six rectangles 41A, 41B inviting the user to enter a signal by touching a chosen one of the rectangles. Three rectangles 41A on the left hand side allow the user to move to other kinds of display whilst three rectangles 41B on the right hand side allow a user to adjust the scale of the right hand side of a graphic display 45 that takes up most of the area of the display. An illuminated spot 42, shown in FIG. 5A on the left hand one of the rectangles 41B shows that the scale of the right hand side has been chosen to be the range indicated by that button, namely 0-100 ppm in this example. By touching the middle rectangle 41B, the spot 42 is moved to the middle rectangle and the scale changed to 0-250 ppm; similarly by touching the right hand rectangle 41B, the spot 42 is moved to that rectangle and the scale changed to 0-500 ppm. Between the rectangles 41A and 41B, the kind of fuel being burnt is indicated; in this particular example it is Light Distillate Oil. The facility to change the scale on the right hand side of the graph is useful because the ppm amounts of some gases will depend very much on the fuel being burnt.

On the right hand side of the touch screen 14, there is a cluster of six rectangles 43 each of which shows in symbols a different gas. An illuminated spot 44 is present on each rectangle referring to a gas whose emissions are indicated graphically on the screen. Below the six rectangles 43, six rows 48 of coloured lines and symbols show the colours of the various gases whose emissions may be shown on the graph and the scale (ppm or %) that applies. In the particular example shown five of the six rectangles 43 include an illuminated spot 44, but the sixth (NO) does not and therefore the emissions of NO are not shown.

In FIG. 5A (and FIGS. 5B to 5F) the plots shown are for the following gases (reading from top to bottom): CO₂; SO₂; O₂; NO₂ and CO. Of those CO₂ and O₂ are measured as a percentage (left hand scale) and SO₂, NO₂ and CO are measured in ppm (right hand scale).

By touching each rectangle 43, its illuminated spot 44 can be switched between its illuminated state and its invisible state, and at the same time the emissions information added to or removed from the graphic display 45. Thus in the example shown there is no emissions information given for NO.

Along the bottom of the graphic display, the months from January to the following January are shown. Thus it can be seen, for example, that throughout the year emissions of CO₂ have in this particular example been in the range of 12% to 14%, while emissions of CO have generally been between 0 and 10 ppm, peaking in June at a little over 10 ppm.

FIGS. 5B, 5C, 5D, 5E and 5F show displays that are similar in many respects to that shown in FIG. 5A and can be reached from the display shown in FIG. 5A: towards the bottom right hand corner of FIG. 5A is a rectangle 46 labelled “Next”; touching the rectangle 46 causes the screen to move to the next display, which is shown in FIG. 5B, where it will be seen that the rectangle 46 is supplemented by a rectangle 47 labelled “Back”. FIGS. 5C, 5D and 5E show displays which similarly include both the rectangle 46 and the rectangle 47 whilst a final display shown in FIG. 5F includes only the rectangle 47 labelled “Back”. By touching the rectangle 46, a user may advance in turn from the display shown in FIG. 5A through each of the displays shown in FIGS. 5B to 5E finally arriving at the display shown in FIG. 5F. Also of course a user can move from one display to another and back again by touching the appropriate rectangles.

The displays shown in FIGS. 5B to 5F are generally similar to that shown in FIG. 5A and the same parts of the displays are referenced by the same reference numerals. Because a user chooses the ppm scale and the gases which are illustrated graphically on the display shown in FIG. 5A, by touching appropriate ones of the rectangles 41B and 43, those rectangles are not repeated in the displays of FIGS. 5B to 5F. Otherwise the displays of FIGS. 5B to 5F differ in what is shown along the x-axis as follows:

in FIG. 5B the x-axis covers a three month period or one month period (and the three month or one month period that is displayed is that selected by a user touching the x-axis of the screen shown in FIG. 5A and selecting by dragging the time period of interest);

in FIG. 5C, the period is reduced to four one week intervals (and again the month can be selected by touching and dragging on the x-axis of FIG. 5B;

in FIG. 5D, the period is one week divided into seven one day intervals and again the week can be selected by touching and dragging as before;

in FIG. 5E, the period is one day divided into 24 one hour intervals and again the day can be selected by touching and dragging as before; and

in FIG. 5F, the period is one hour divided into 60 one minute intervals and again the hour can be changed by touching and dragging as before.

Thus it can be seen that the displays shown in FIGS. 5A to 5F provide a user with a wide selection of information regarding emissions. Whilst FIGS. 5A to 5F show displays in black and white, it should be understood that each display is preferably a colour display.

The data from which the displays of FIGS. 5A to 5F are generated may be stored on a removable memory device which may for example be connectible to a laptop computer to allow other processing of the data by a user.

Many other displays are also available including for example ones showing cost information. Also each display can be shown in either Imperial or SI units.

As will be understood, the monitoring unit described above allows a user to interrogate data through a variety of interfaces and also allows a user to tailor queries for explicit information regarding emissions. For example, a user might request information as to the highest rate of emission for a particular gas during the past month or the total emissions of a gas since installation of the unit. The monitoring unit provides in a single system that can be very user friendly a source of both current and historical data of great value in emissions monitoring.

In the description above a particular example of the invention has been described with reference to the drawings and it should be understood that many modifications may be made to the example without departing from the invention.

1. A method of operating a burner comprising:
providing a monitoring unit;
monitoring the firing rate of the burner and feeding an input signal representing the firing rate to the monitoring unit;
monitoring the respective proportions of a plurality of gases in exhaust emissions from the burner and feeding input signals representing the respective proportions to the monitoring unit;
calculating in the monitoring unit, from a combination of the input signals representing the firing rate of the burner and the respective proportions of gases in exhaust emissions, the amount of one or more of the plurality of gases emitted from the burner; and
displaying at least one of the amounts on a display.

2. A method according to claim 1, in which the monitoring unit calculates the momentary amount of one or more of the plurality of gases emitted from the burner.

3. A method according to claim 2, in which the monitoring unit calculates the momentary amount of one or more of the plurality of gases emitted from the burner a multiplicity of times and stores the results of each calculation in the monitoring unit.

4. A method according to claim 1, in which the monitoring unit calculates the aggregate amount of one or more of the plurality of gases emitted over a period of time from the burner.

5. A method according to claim 4, in which the monitoring unit calculates the aggregate amount by calculating the momentary amount a multiplicity of times and integrating the results.

6. A method according to claim 1, in which said at least one of the amounts displayed includes the momentary rate of emission of an exhaust gas.

7. A method according to claim 1, in which said at least one of the amounts displayed includes the aggregate amount of an exhaust gas emitted over a period of time.

8. A method according to claim 7, in which the period of time over which the aggregate amount emitted is displayed can be altered by a user.

9. A method according to claim 1, further comprising the step of feeding an input signal to the monitoring unit indicating the type of fuel being fed to the burner.

10. A method according to claim 1, in which the amounts of each of the plurality of gases whose proportions are monitored are calculated in the monitoring unit.

11. A method according to claim 1, in which the amounts of each of the plurality of gases whose proportions are calculated are displayed.

12. A method according to claim 1, in which the display includes a touch screen through which an input to the monitoring unit is provided.

13. A method according to claim 1, in which the display is capable of displaying simultaneously emissions data relating to a plurality of exhaust gases.

14. A method according to claim 13, in which a user is able to select for which one or ones of the plurality of exhaust gases emissions data is displayed.

15. A method according to claim 1, in which the display includes a graphical display and a user is able to adjust a scale on one or both axes.

16. A method according to claim 1, in which the step of monitoring the firing rate of the burner comprises monitoring the flow rate of fuel to the burner.

17. A burner installation comprising:
a burner;
a monitoring unit including a housing and a display;
a monitor for monitoring the firing rate of the burner and feeding an input signal representing the firing rate to the monitoring unit;
exhaust gas analysis equipment for monitoring the respective proportions of a plurality of gases in exhaust emissions from the burner and feeding input signals representing the respective proportions to the monitoring unit; and
a calculating unit in the monitoring unit for calculating, from a combination of the input signals representing the firing rate of the burner and the respective proportions of gases in exhaust emissions, the amount of one or more of the plurality of gases emitted from the burner.

18. A burner installation according to claim 17, in which the calculating unit is arranged to calculate the momentary amount of one or more of the plurality of gases emitted from the burner.

19. A burner installation according to claim 18, in which the monitoring unit includes a store and the calculating unit is arranged to calculate the momentary amount of one or more of the plurality of gases emitted from the burner a multiplicity of times and to store the results of each calculation in the store.

20. A burner installation according to any claim 17, in which the monitoring unit is arranged to calculate the aggregate amount of one or more of the plurality of gases emitted over a period of time from the burner.

21. A burner installation according to claim 17, in which the monitoring unit is arranged to receive an input signal indicating the type of fuel being fed to the burner.

22. A burner installation according to claim 17, in which the display includes a touch screen for enabling an input to the monitoring unit to be provided.

23. A burner installation according to claim 22, in which the housing of the monitoring unit includes a top face on which the display and the touch screen are provided.
